(19) United States
(12) Patent Application Publication
(10) Pub. No.: US 2026/0077765 A1
(43) Pub. Date: Mar. 19, 2026

(54) DRIVE ASSIST DEVICE

(71) Applicant: TOYOTA JIDOSHA KABUSHIKI KAISHA, Aichi-ken (JP)

(72) Inventors: Shogo ITO, Shizuoka-ken (JP); Shinya Kawamata, Shizuoka-ken (JP); Kumiko Kondo, Shizuoka-ken (JP)

(73) Assignee: TOYOTA JIDOSHA KABUSHIKI KAISHA, Aichi-ken (JP)

(21) Appl. No.: 19/244,576

(22) Filed: Jun. 20, 2025

(30) Foreign Application Priority Data
Sep. 18, 2024 (JP) 2024-161062

(51) Int. Cl. B60W 30/14; B60W 50/10

(52) U.S. Cl. CPC B60W 30/146; B60W 50/10; B60W 2520/10; B60W 2540/10; B60W 2552/15; B60W 2554/802

(57) ABSTRACT

The drive assist device is configured to execute deceleration control for decelerating the vehicle with respect to a deceleration target object existing in front of the vehicle. The drive assist device starts the deceleration control when the driver performs a predetermined deceleration intention operation on the accelerator pedal of the vehicle, and ends the deceleration control when the driver performs the predetermined acceleration intention operation on the accelerator pedal, and suppresses the deceleration control as compared with a case where the descending gradient condition is not satisfied when the vehicle travels on the descending gradient.

### CROSS-REFERENCE TO RELATED APPLICATION

This application claims priority to Japanese Patent Application No. 2024-161062 filed on Sep. 18, 2024. The disclosure of the above-identified application, including the specification, drawings, and claims, is incorporated by reference herein in its entirety.

### BACKGROUND

### 1. Technical Field

The present disclosure relates to a drive assist device configured to execute deceleration control for decelerating a vehicle with respect to a deceleration target existing ahead of the vehicle.

### 2. Description of Related Art

Conventionally, a drive assist device that executes deceleration control with respect to a deceleration target has been known. For example, Japanese Unexamined Patent Application Publication No. 2022-065285 (JP 2022-065285 A) describes a drive assist device (hereinafter referred to as a “conventional device”) that executes deceleration control when the distance to a deceleration target object is equal to or less than a threshold and an accelerator pedal is not depressed, and cancels the execution of the deceleration control when the accelerator pedal is operated while the deceleration control is executed. To cancel the execution of the deceleration control, the conventional device decreases the deceleration of the deceleration control faster as the degree of the operation of the accelerator pedal is greater.

### SUMMARY

When a driver feels that the deceleration of the deceleration control is strong, the driver cancels the execution of the deceleration control (that is, ends the deceleration control) by operating the accelerator pedal. After the deceleration control is ended, the vehicle accelerates in response to the operation of the accelerator pedal. The vehicle easily accelerates when the vehicle travels on a downward slope, compared to when the vehicle travels on a flat road or an upward slope. When the driver feels that the deceleration of the deceleration control is too strong while the vehicle is traveling on a downward slope, the driver may end the deceleration control by operating the accelerator pedal. In this case, the vehicle may accelerate faster than the acceleration of the vehicle intended by the driver. Such acceleration of the vehicle faster than the driver's intention is highly likely to cause anxiety to the driver.

The present disclosure has been made to address the above-mentioned issue. That is, an object of the present disclosure is to provide a drive assist device that reduces the possibility that a driver ends deceleration control by operating an accelerator pedal, by reducing the possibility that the driver feels strong deceleration due to deceleration control executed when a vehicle is traveling on a downward slope.

An aspect of the present disclosure provides a vehicle control device (hereinafter referred to as a “present disclosure device”) configured to execute deceleration control for decelerating a vehicle with respect to a deceleration target existing ahead of the vehicle (steps 200 to 295).

Further, the drive assist device is configured to:
start the deceleration control (step 230) when a driver performs a predetermined deceleration intention operation (step 225 “Yes”) on an accelerator pedal (30a) of the vehicle;
end the deceleration control (step 260) when the driver performs a predetermined acceleration intention operation (step 245 “Yes”) on the accelerator pedal (30a); and
suppress the deceleration control (step 335) when a downward slope condition that the vehicle is traveling on a downward slope is satisfied (step 310 “Yes”), compared to when the downward slope condition is not satisfied (step 310 “No”, step 315).

According to the present disclosure device, the deceleration control is suppressed when the downward slope condition is satisfied, compared to when the downward slope condition is not satisfied. Therefore, it is possible to reduce the possibility that the driver feels that the deceleration of the deceleration control is too strong when the vehicle is traveling on a downward slope. Accordingly, it is possible to reduce the possibility that the driver ends the deceleration control by operating the accelerator pedal when the vehicle is traveling on a downward slope. Thus, it is possible to reduce the possibility of causing anxiety to the driver by accelerating the vehicle faster than the driver's intention when the vehicle is traveling on a downward slope.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic system configuration diagram of a drive assist device according to an embodiment of the present disclosure;

FIG. 2 is a flow chart of a deceleration control routine executed by CPU of ECU shown in FIG. 1;

FIG. 3 is a flow chart of a target deceleration acquisition subroutine performed by CPU of ECU shown in FIG. 1;

FIG. 4 is a graph showing a time-series change in deceleration of deceleration control executed by the drive assist device according to the first modification of the embodiment of the present disclosure;

FIG. 5 is a graph showing a time-series change in the deceleration of the deceleration control executed by the drive assist device according to the first modification of the embodiment of the present disclosure; and

FIG. 6 is a graph showing time-series changes in deceleration of deceleration control executed by the drive assist device according to the second modification of the embodiment of the present disclosure.

### DETAILED DESCRIPTION OF EMBODIMENTS

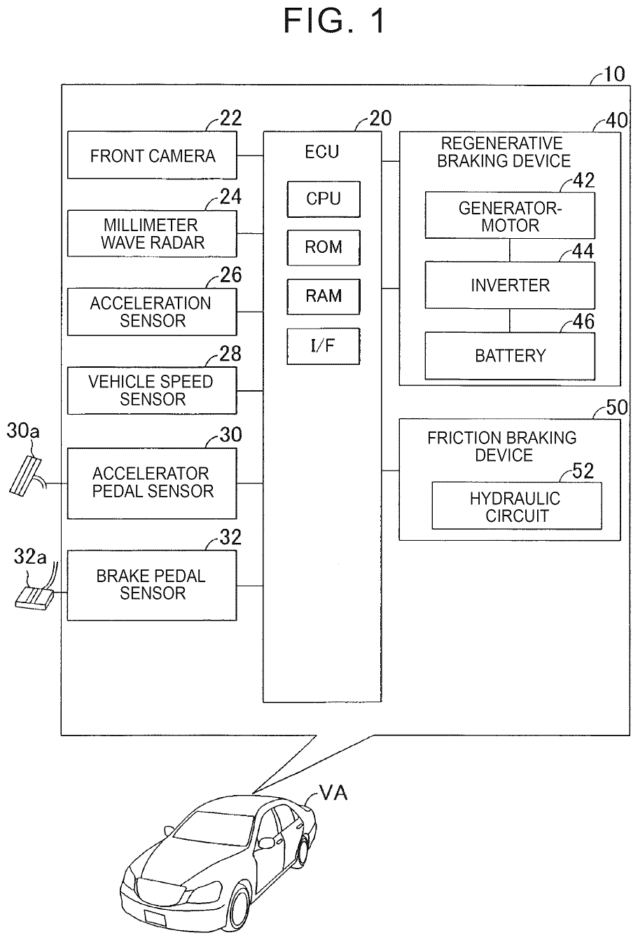

The drive assist device 10 (hereinafter, also referred to as “the device 10”) according to the embodiment of the present disclosure is applied to a vehicle VA and includes the components illustrated in FIG. 1. In the present specification, “ECU 20” is an electronic control device including a microcomputer as a main part. ECU 20 is also referred to as control units, controllers and computers. The microcomputer includes a CPU (processor), a ROM, RAM, and interfaces (I/F). The function realized by ECU 20 may be realized by a plurality of ECU.

The front camera 22 captures an image of a scene in front of the vehicle VA. The millimeter wave radar 24 receives the reflected wave reflected by the object by the millimeter wave transmitted to the front of the vehicle VA, and acquires radar data regarding the position of the object with respect to the vehicle VA. ECU 20 acquires image data from the front camera 22 and acquires radar data from the millimeter-wave radar 24. ECU 20 recognizes objects in front of the vehicle VA based on the imaging data and the radar data.

The acceleration sensor 26 measures an acceleration Gx of the vehicle VA in the front-rear direction and an acceleration Gy of the vehicle VA in the vertical direction. The vehicle speed sensor 28 measures a vehicle speed Vs representing the speed of the vehicle VA. The accelerator pedal sensor 30 measures an accelerator pedal operation amount AP representing a depression amount of the accelerator pedal 30a. The brake pedal sensor 32 measures a brake pedal operation amount BP representing a depression amount of the brake pedal 32a. The accelerator pedal operation amount AP and the brake pedal operation amount BP become larger as the depression amount of the accelerator pedal 30a and the brake pedal 32a increases, respectively. Further, the accelerator pedal operation amount AP and the brake pedal operation amount BP become “0” when the accelerator pedal 30a and the brake pedal 32a are not depressed (when they are not depressed), respectively. ECU 20 obtains measurements of these sensors 26-32.

The regenerative braking device 40 includes a generator motor 42, an inverter 44, and a battery 46. The generator motor 42 is, for example, an AC synchronous motor. The output shaft of the generator motor 42 is connected to the drive wheels so that power generated on the output shaft is transmitted to the drive wheels of the vehicle VA. The battery 46 is a power storage device that can be charged and discharged. The inverter 44 is electrically connected to the battery 46. When the generator motor 42 operates as a generator, the generator motor 42 converts the rotational (kinetic) energy of the drive wheels into electrical energy (AC power). In this case, regenerative braking force is generated in the drive wheels. The inverter 44 converts AC power supplied from the generator motor 42 into DC power, and supplies the DC power to the battery 46. In this way, the battery 46 is charged. On the other hand, when the generator motor 42 operates as an electric motor, the inverter 44 converts DC power supplied from the battery 46 into AC power and supplies the AC power to the generator motor 42. As a result, the generator motor 42 is driven, and a driving force is applied to the driving wheels. As described above, the generator motor 42 functions not only as a driving actuator that applies a driving force to the driving wheels but also as a braking actuator that applies a regenerative braking force to the driving wheels.

The friction braking device 50 includes a hydraulic circuit 52 that functions as a braking actuator. The hydraulic circuit 52 operates the wheel cylinders by supplying hydraulic pressure to wheel cylinders (not shown) disposed corresponding to the respective wheels. When the wheel cylinder is actuated, a brake pad (not shown) is pressed against a brake disc of each wheel, so that a friction braking force is generated in each wheel.

### Deceleration Control

ECU 20 performs deceleration control on a deceleration target in front of the vehicle VA. The deceleration control is a control for decelerating the vehicle VA. ECU 20 recognizes the decelerating object based on the imaging data and the radar data. For example, the deceleration target is a preceding vehicle, a curve road, a “traffic light instructing a stop”, a stop line, or the like. The preceding vehicle is another vehicle that travels in the same lane as the vehicle VA and is located in front of the vehicle VA. When ECU 20 recognizes the deceleration target, it acquires a target deceleration Gtgt for achieving “any one of the targets 1 to 3 corresponding to the deceleration target”.

### Target 1

When the deceleration target is a preceding vehicle, the vehicle-to-vehicle time Tve is equal to or greater than the threshold-time Tth. The inter-vehicle time Tve is a time period from when the preceding vehicle passes through a certain point until when the vehicle VA passes through the point.

### Target 2

When the deceleration target is a curve road, the vehicle speed Vs becomes “a curve vehicle speed Vcv appropriate for the vehicle VA to travel on the curve road”. The curve vehicle speed Vcv is acquired based on the curvature of the curve road. ECU 20 detects the white line of the lane on which the vehicle VA is traveling based on the image-data, and acquires the curvature based on the white line.

### Target 3

When the deceleration target is a traffic light or a stop line, the vehicle speed Vs becomes the stop vehicle speed Vst at a target point in front of the traffic light or the stop line.

### Start Condition

When both of the following condition S1 and S2 are satisfied, ECU 20 determines that the start condition is satisfied and starts the deceleration control. Conditional S1: The target deceleration Gtgt is greater than or equal to the threshold deceleration Gth. Conditional S2: The driver attempted to decelerate the accelerator pedal 30a. Details of the deceleration intention operation will be described later.

### Termination Condition

When the target corresponding to the deceleration target is achieved, ECU 20 determines that the termination condition is satisfied and ends the deceleration control.

ECU 20 determines that the accelerator override has occurred when the accelerator pedal 30a of the driver is subjected to an acceleration intent manipulation indicating the acceleration intent, and ends the deceleration control.

### Overview of Operation

ECU 20 acquires the inclination θ of the road on which the vehicle VA is traveling based on the acceleration Gy measured by the acceleration sensor 26. When the vehicle VA is traveling on a flat road, the inclination θ is “0 deg”. If the vehicle VA is traveling on a downward slope, the slope θ is negative. If the vehicle VA is traveling on an upward slope, the slope θ is positive.

ECU 20 determines whether or not a downward slope condition is satisfied based on the slope θ. ECU 20 determines that the vehicle VA is traveling on a downward slope when the downward slope is satisfied. For example, when the slope θ is equal to or less than the threshold slope θth set to a predetermined value smaller than 0, ECU 20 determines that the downward slope condition is satisfied.

When the downward slope condition is satisfied, ECU 20 suppresses the deceleration control (reduces the degree of intervention of the deceleration control) than when the downward slope condition is not satisfied.

When the down-slope condition is satisfied, the deceleration control is suppressed more than when the down-slope condition is not satisfied. Therefore, the possibility of depressing the accelerator pedal 30a due to the driver's feeling that the deceleration of the deceleration control is too strong can be reduced. As a result, when the vehicle VA is traveling on a downward slope, the deceleration control is terminated due to the occurrence of the accelerator override, and the possibility that the vehicle VA accelerates faster than intended by the driver can be reduced. Therefore, according to the present device 10, it is possible to reduce a possibility that the driver is worried when the vehicle VA is traveling on a downward slope.

### Specific Operation

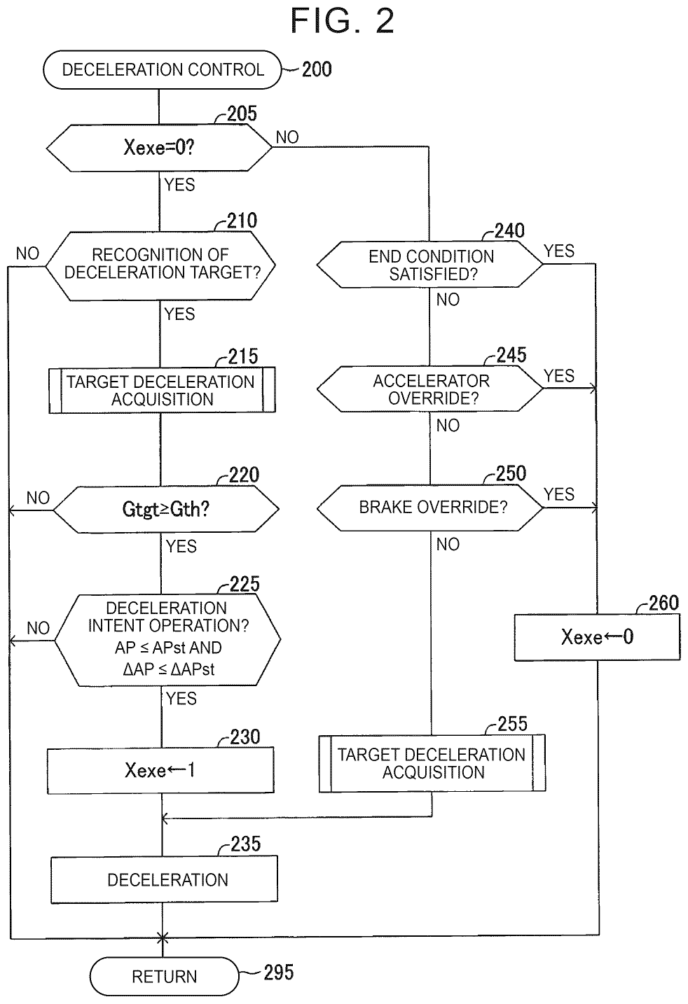

CPU of ECU 20 is executed every time a predetermined period of time elapses in the deceleration control routine illustrated by the flow chart in FIG. 2. When the appropriate time point has arrived, CPU starts the process from step 200 of FIG. 2, and in step 205, CPU determines whether or not the execute flag Xexe is “0”.

The execution flag Xexe is set to “1” when the deceleration control is executed and is set to “0” when the deceleration control is not executed. The execute flag Xexe is set to “0” in the initialization routine. The initialization routine is executed by CPU when an ignition-key switch (not shown) of the vehicle VA is changed from the off-position to the on-position.

If the run flag Xexe is “0” (step 205 “Yes”), CPU determines whether or not the object to be decelerated is recognized based on the image data and the radar data in step 210.

If the deceleration target is recognized (step 210 “Yes”), CPU performs steps 215 and 220.
The step 215: CPU executes a target deceleration acquisition subroutine for acquiring the target deceleration Gtgt. The larger the target deceleration Gtgt, the stronger the deceleration of the vehicle VA. Details of the target deceleration acquisition subroutine will be described later.
The step 220: CPU determines whether or not the target deceleration Gtgt is equal to or greater than the threshold deceleration Gth.

If the target deceleration Gtgt is greater than or equal to the threshold deceleration Gth (step 220 “Yes”), CPU determines in step 225 whether or not the driver has performed the deceleration intention manipulation in the accelerator pedal 30a. Specifically, when both the first operation condition and the second operation condition are satisfied, CPU determines that the driver has performed the deceleration intention operation in the accelerator pedal 30a. The first operation condition is that the accelerator pedal operation amount AP is equal to or less than the deceleration starting operation amount APst. The second operation condition is that the change amount ΔAP of the accelerator pedal operation amount AP is equal to or less than the “deceleration starting change amount ΔAPst set to a predetermined negative value”. Note that the change amount ΔAP is obtained by subtracting “the accelerator pedal operation amount APp at a predetermined time earlier than the current time” from the accelerator pedal operation amount AP at the current time. When the driver loosens the depression of the accelerator pedal 30a, the variation ΔAP is negative.

When the driver performs the deceleration intentional manipulation in the accelerator pedal 30a (step 225 “Yes”), CPU executes step 230 and step 235.
The step 230: CPU sets the execute flag Xexe to “1”.
The step 235: CPU controls at least the regenerative braking device 40 among the regenerative braking device 40 and the friction braking device 50 to generate a braking force Fd such that the acceleration Gx of the vehicle VA coincides with the target deceleration Gtgt. Specifically, CPU acquires the braking force Fd required to make the acceleration Gx coincide with the target deceleration Gtgt. When the braking force Fd is equal to or less than “the greatest braking force that the regenerative braking device 40 can generate”, CPU causes the regenerative braking device 40 to generate a braking force Fd. If the braking force Fd is greater than the maximum braking force, CPU causes the regenerative braking device 40 to generate a maximum braking force, and causes the friction braking device 50 to generate a “braking force corresponding to the amount obtained by subtracting the maximum braking force from the braking force Fd”.
After that, the process proceeds to step 295, and CPU ends the routine once.

If the deceleration target is not recognized (step 210 “No”), if the target deceleration Gtgt is less than the threshold deceleration Gth (step 220 “No”), or if the driver does not perform the deceleration intention manipulation (step 225 “No”), the process proceeds to step 295. As a result, the deceleration control is not started.

If the execution flag Xexe is “1” when the process proceeds to step 205 (step 205 “No”), CPU determines whether or not the termination condition is satisfied in step 240. More specifically, when the deceleration target is a preceding vehicle, when the inter-vehicle time Tve becomes equal to or larger than the threshold time tth, the termination condition is satisfied. When the deceleration target is a curve road, when the vehicle speed Vs coincides with the curve vehicle speed Vcv, the termination condition is satisfied. When the deceleration target is a traffic light or a stop line, the end condition is satisfied when the acceleration Gx coincides with “the stop deceleration for the vehicle speed Vs to coincide with the stop vehicle speed Vst at the target point”.

If the termination condition is not satisfied (step 240 “No”), CPU determines whether or not an accelerator override has occurred in step 245. When one of the third operation condition and the fourth operation condition is satisfied, CPU determines that the accelerator override has occurred. The third operation condition is that the change amount ΔAP is equal to or greater than the “acceleration change amount ΔAPac set to a predetermined positive value”. The fourth operation condition is that the accelerator pedal operation amount AP is larger than the deceleration starting operation amount APst.

If an accelerator override has not occurred (step 245 “No”), CPU determines whether a brake override has occurred in step 250. When the brake pedal 32a is depressed, CPU determines that a brake override has occurred.

If the brake override has not occurred (step 250 “No”), CPU executes the target deceleration obtaining subroutine in step 255, and the process proceeds to step 235.

When the termination condition is satisfied (step 240 “Yes”), when the accelerator override occurs (step 245 “Yes”) and when the brake override occurs (step 250 “Yes”), CPU sets the execute flag Xexe to “0” in step 260, and the process proceeds to step 295.

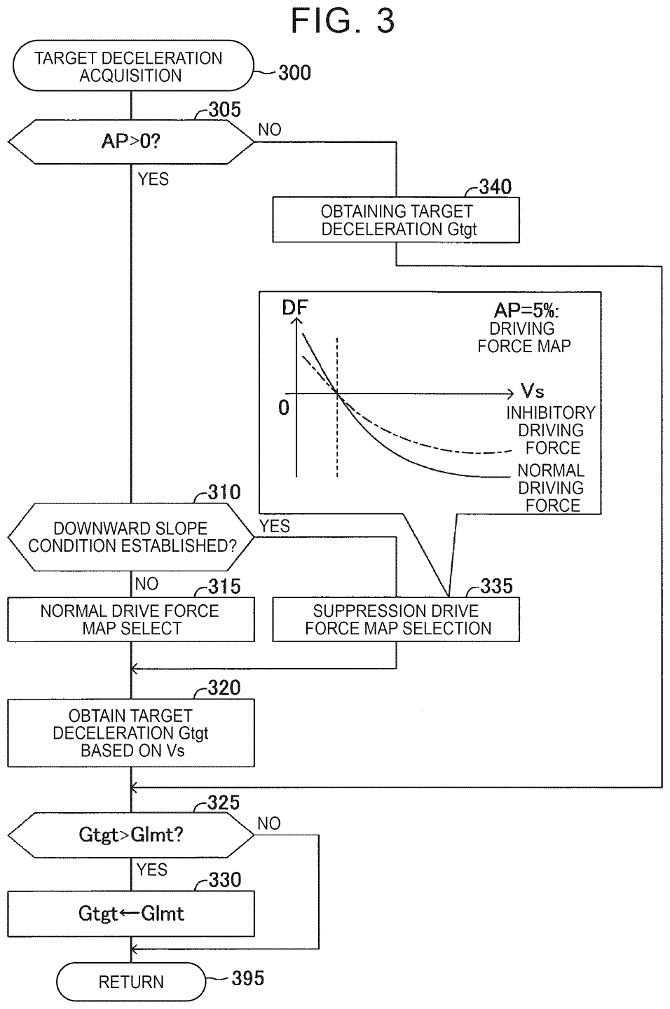

If the process proceeds to step 215 or step 255, CPU starts the process from step 300 of FIG. 3 and the process proceeds to step 305. In step 305, CPU determines whether or not the accelerator pedal-operation-amount AP is greater than “0”.

If the accelerator pedal-operation-amount AP is greater than “0” (step 305 “Yes”), CPU determines in step 310 whether or not the down-slope condition is satisfied.

If the down gradient is not satisfied (step 310 “No”), CPU executes steps 315 to 325.
The step 315: CPU selects a normal driving force map corresponding to the accelerator pedal-operation-amount AP. The device 10 stores a normal driving force map and a reduced driving force map for each accelerator pedal-operation-amount AP. These driving force maps define the relation between the vehicle speed Vs and the driving force DF. According to these driving force maps, as the vehicle speed Vs increases, the driving force DF decreases. In the normal driving force map and the suppressed driving force map, when the vehicle speed Vs becomes larger than a certain vehicle speed, the driving force DF becomes negative. When the driving force DF becomes negative, a braking force is applied to the wheels. When the driving force DF becomes negative, the driving force DF corresponding to the same vehicle speed Vs becomes larger in the suppressing driving force map than in the normal driving force map. That is, the braking force of the suppression driving force map is suppressed more than the braking force of the normal driving force map.

The step 320: CPU acquires the driving force DF by applying the vehicle speed Vs to the selected normal driving force map, and acquires the target deceleration Gtgt for generating the braking force corresponding to the driving force DF. When the driving force DF is positive, the target deceleration Gtgt is “0”.

The step 325: CPU determines whether or not the target deceleration Gtgt is larger than the upper limit deceleration Glmt.

If the target deceleration Gtgt is greater than the upper limit deceleration Glmt (step 325 “Yes”), in step 330, CPU sets the target deceleration Gtgt to the upper limit deceleration Glmt. Therefore, the target deceleration Gtgt does not become larger than the upper limit deceleration Glmt. After that, the process proceeds to step 395, and CPU ends the routine once. The process then proceeds to step 220 or step 235 shown in FIG. 2. If the target deceleration Gtgt is equal to or less than the upper limit deceleration Glmt (step 325 “No”), the process proceeds to step 395.

If the descending gradient is satisfied when the process proceeds to step 310 (step 310 “Yes”), CPU selects a suppression driving force map corresponding to the accelerator pedal-operation-amount AP in step 335. Thereafter, the process proceeds to step 320, and CPU obtains the target deceleration Gtgt based on the driving force DF obtained by applying the vehicle speed Vs to the selected suppressing driving force map.

When the process proceeds to step 305 and the accelerator pedal operation amount AP is “0” (step 305 “No”), in step 340, CPU acquires the target deceleration Gtgt according to the type of the deceleration target as described above. Processing then proceeds to step 325.

As described above, when the downward gradient is satisfied, the target deceleration Gtgt is acquired using the suppressing driving force map. Therefore, when the downward slope condition is satisfied, the target deceleration Gtgt is smaller than when the downward slope condition is not satisfied. That is, when the down-slope condition is satisfied, the deceleration control is suppressed more than when the down-slope condition is not satisfied. Accordingly, when the deceleration control is executed while the vehicle VA is traveling on the downward slope, the possibility that the driver depresses the accelerator pedal 30a can be reduced. Therefore, it is possible to reduce the possibility of causing the driver to worry by accelerating the vehicle VA faster than the driver's intention.

### First Modification

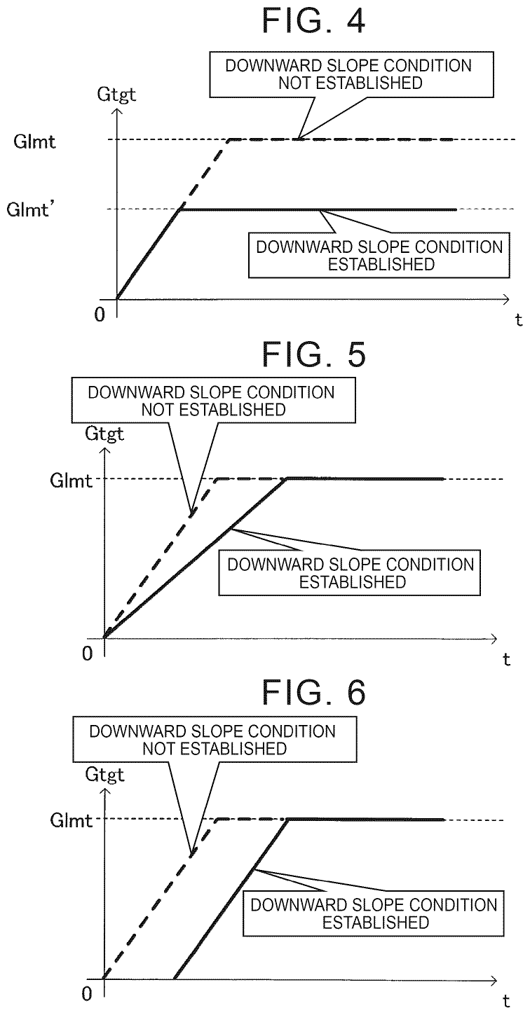

In ECU 20 of the present modification, when the down-slope condition is satisfied, a process of reducing the upper limit deceleration Glmt (first upper limit suppressing process) is executed than when the down-slope condition is not satisfied. In other words, ECU 20 uses the upper limit deceleration Glmt′ smaller than the upper limit deceleration Glmt when the downward slope condition is satisfied and the downward slope condition is not satisfied. FIG. 4 shows time-series changes in the target deceleration Gtgt when the down-slope condition is not satisfied and when the down-slope condition is satisfied. As illustrated in FIG. 4, when the down-slope condition is satisfied, the deceleration control is suppressed more than when the down-slope condition is not satisfied.

When the time change of the target deceleration Gtgt (that is, the time derivative of the deceleration, hereinafter referred to as “jerk J”) is larger than the upper limit jerk Jlmt, ECU 20 sets the target deceleration Gtgt to such a value that the jerk J is equal to or smaller than the upper limit jerk Jlmt. Thus, the jerk J does not exceed the upper limit jerk Jlmt. In the present modification, CPU may execute a process of reducing the upper limit jerk Jlmt (second upper limit suppressing process) as compared with a case where the downward slope condition is not satisfied when the downward slope condition is satisfied. FIG. 5 shows time-series changes in the target deceleration Gtgt when the down-slope condition is not satisfied and when the down-slope condition is satisfied.

When the downward slope condition is satisfied, at least one of the first upper limit value suppression process and the second upper limit value suppression process may be executed.

### Second Modification

ECU 20 according to the present modification executes at least one of a start timing process and an end timing process when the down gradient is satisfied. The start timing process is a process of making the start timing of the deceleration control slower than in the case where the downward slope condition is not satisfied (making the start condition less likely to be satisfied). The end timing process is a process of advancing the end timing of the deceleration control (making the end condition easier to be satisfied) than in the case where the downward slope condition is not satisfied. Since the execution time of the deceleration control is shortened by delaying the start timing and/or accelerating the end timing, the deceleration control is suppressed.

The start timing processing will be described in detail. When the down-slope condition is satisfied, ECU 20 sets the threshold-deceleration Gth used in step 220 shown in FIG. 2 to be larger than when the down-slope condition is not satisfied. Further, when the down-slope condition is satisfied, ECU 20 sets the deceleration starting operation amount APst used in step 225 shown in FIG. 2 to be smaller than when the down-slope condition is not satisfied. ECU 20 is set so that the deceleration starting change amount ΔAPst is smaller than when the downward gradient is not satisfied. FIG. 6 shows time-series changes in the target deceleration Gtgt in a case where the start timing process is not executed (a case where the downward slope condition is not satisfied) and in a case where the start timing process is executed (a case where the downward slope condition is satisfied). It should be noted that at least one of the threshold-deceleration Gth, the deceleration starting operation amount APst, and the deceleration starting change amount ΔAPst may be changed so as to make it difficult for the start condition to be satisfied.

The end timing processing will be described in detail. ECU 20 reduces the threshold-time Tth used for the ending condition when the deceleration target is the preceding vehicle, as compared with the case where the descending gradient condition is not satisfied when the descending gradient condition is satisfied. ECU 20 increases the curve vehicle speed Vcv used for the ending condition when the deceleration target is a curve road, as compared with the case where the descending gradient condition is not satisfied when the descending gradient condition is satisfied. ECU 20 reduces the stop deceleration used for the termination condition when the deceleration target is a traffic light or a stop line, as compared with the case where the downward slope condition is not satisfied when the downward slope condition is satisfied.

When at least one of the first operation condition and the second operation condition is satisfied, CPU may determine that the driver has performed the deceleration intention operation. Further, when both the third operation condition and the fourth operation condition are satisfied, CPU may determine that the driver has performed the acceleration intent operation. The deceleration starting operation amount APst used for the first operation condition may differ from the deceleration starting operation amount APst used for the fourth operation condition. It is also possible to combine at least one of the above-described embodiment, the first modification, and the second modification.

The device 10 is applicable to vehicles such as engined vehicles, hybrid electric vehicle, plug-in hybrid vehicles, fuel cell electric vehicle, and battery electric vehicle. The device 10 is also applicable to an autonomous vehicle.

What is claimed is:

1. A drive assist device configured to execute deceleration control for decelerating a vehicle with respect to a deceleration target existing ahead of the vehicle, wherein the drive assist device is configured to:
start the deceleration control when a driver performs a predetermined deceleration intention operation on an accelerator pedal of the vehicle;
end the deceleration control when the driver performs a predetermined acceleration intention operation on the accelerator pedal; and
suppress the deceleration control when a downward slope condition that the vehicle is traveling on a downward slope is satisfied, compared to when the downward slope condition is not satisfied.

2. The drive assist device according to claim 1, wherein the drive assist device is configured to:
decelerate the vehicle at an operation deceleration determined based on a speed of the vehicle and an operation amount of the accelerator pedal in the deceleration control; and
suppress the deceleration control by reducing the operation deceleration when the downward slope condition is satisfied, compared to when the downward slope condition is not satisfied.

3. The drive assist device according to claim 1, wherein the drive assist device is configured to suppress the deceleration control when the downward slope condition is satisfied by executing at least one of:
a first upper limit value suppressing process of reducing an upper limit value of deceleration in the deceleration control compared to when the downward slope condition is not satisfied; and
a second upper limit value suppressing process of reducing an upper limit value of a time change of the deceleration in the deceleration control compared to when the downward slope condition is not satisfied.

4. The drive assist device according to claim 1, wherein the drive assist device is configured to suppress the deceleration control when the downward slope condition is satisfied by executing at least one of:
a start timing process of delaying a start timing of the deceleration control compared to when the downward slope condition is not satisfied, and
an end timing process of advancing an end timing of the deceleration control compared to when the downward slope condition is not satisfied.
